(19) United States
(12) Patent Application Publication
(10) Pub. No.: US 2005/0227200 A1
(43) Pub. Date: Oct. 13, 2005

(54) Endodontic file and method

(76) Inventor: Hessam Ahani, Pacifica, CA (US)

Correspondence Address: CARPENTER & KULAS, LLP, 1900 EMBARCADERO ROAD, SUITE 109, PALO ALTO, CA, 94303, US

(21) Appl. No.: 10/858,329

(22) Filed: Jun. 1, 2004

Related U.S. Application Data
(63) Continuation of application No. 10/133,269, filed on Apr. 26, 2002, now abandoned.
(60) Provisional application No. 60/325,669, filed on Sep. 28, 2001.

(51) Int. Cl. A61C 5/02

(52) U.S. Cl. 433/102

(57) ABSTRACT

An endodontic file comprising a conductive shank, and a generally non-conductive portion circumscribing the conductive shank and longitudinally extending along the conductive shank. A method for conducting an endodontic procedure comprising providing an endodontic file assembly having a conductive shank electrically engaged to an electronic device for furnishing current to the conductive shank. A generally non-conductive portion circumscribes the conductive shank. The conductive shank including the non-conductive portion passes into a root canal of a tooth for conducting an endodontic procedure.

Cross References To Related Applications This application claims the benefit of U.S. Provisional Application 60/325,669 filed Sep. 28, 2001.

### BACKGROUND OF THE INVENTION

1. Field of the Invention

This invention is related to a dental instrument and method. More specifically, embodiments of the present invention provide an endodontic file and method for performing a root canal on a tooth.

2. Description of the Prior Art

In the past, a major problem during a root canal procedure was identifying the length of each canals. This was even more difficult because some teeth have four or even five canals. To measure the length of a canal, a guess was made by measuring the root on an X-ray. Of course X-rays are often distorted and root canals often are shorter than the actual roots. After a guess was made by measuring the root on an X-ray, an endodontic file is placed in the tooth and another X-ray is taken. By doing this procedure, one can see how close one is to the end of the root.

This procedure was made much easier by the advent of an Apex Locator, such as, by way of example only, the Apex Locator sold under the trade name Foramatron D-10 All-Modes Apex Locator to Parkell Inc., 155 Schmitt Blvd, Box 376, Farmingdale, N.Y. 11735. The Foramatron D-10 is a multi-frequency Apex Locator that quickly pinpoints the apical foramen even when the canal is contaminated with conductive electrolytes like sodium hypochlorite and anesthetic solution. Multi-colored lights track the progress of your instrument down the canal. Corresponding audio tones allow a dentist to focus on the patient without watching the machine. Thus, and as best shown in FIGS. 1 and 2, the Apex Locator includes an electronic instrument 32 electrically engaged to a clip 80 via conductor 34. Clip 80 is coupled to a file 10 (e.g., conventional file 10) and a ground conductor 35 placed on the lip of a patient and functions as a ground for closing a circuit. As the dentist inserts the file 10 through the end of a canal 70 of a tooth 72 and into the tissue, the Apex Locator rings and lets the dentist know that the end of the canal 70 is reached. Then, a rubber stopper 81 is slid down the file 10 to a reference point on the tooth 72, which is typically on the top portion of the tooth. The file 10 is then removed and measured to determine length of the root canal 70. Usually, X-rays are then taken to verify the determined length. The Apex Locator is quickly becoming the standard of care in dentistry.

However, using the Apex Locator is somewhat cumbersome. The clip 80 that attaches to the file 10 is large and attaches just under a file handle 11 (see FIG. 1). In the back molar areas, space is limited and the clip 80 often blocks the vision of the dentist. Furthermore, since the clip 80 is tight around the file 10, it limits the dentist's tactile sense, and makes it difficult to rotate the file 10 down the canal 70. Another reason why the Apex Locator is cumbersome is that endodontic files are usually 21 mm or 25 mm long (30 mm files are seldom used). They are made at these lengths because most canals 70 are about 21 mm or about 25 mm in length. Since the clip 80 of the Apex Locator is attached underneath the file handle 11, and a stopper 81 is either under the clip 80 or above it, the file effective length of the file 10 becomes 1 to 3 mm shorter, depending on where the clip 80 is attached on the file 10. This means that many times the dentist cannot push the engaged file 10 down far enough and would have to switch to a longer file. Furthermore, a major problem when using an Apex Locator is when a tooth has any type of metal restoration in it. Most teeth that need root canals typically have some type of restorations, which are usually metal. If the clip 80 or the file 10 touches any of the metal restoration, the Apex Locator quickly shorts out and is useless.

Therefore, what is needed and what has been invented is an endodontic file without the foregoing deficiencies. What is further needed and what has been invented is an improved endodontic file and an improved method for performing a root canal in a tooth.

### SUMMARY OF THE INVENTION

Embodiments of the present invention provide an endodontic file comprising a conductive shank; and a generally non-conductive portion circumscribing the conductive shank and longitudinally extending along the conductive shank. An electronic device is electrically coupled to the conductive shank, and color indicia is preferably disposed on the non-conductive portion for indicating what portion of the length of the conductive shank passes into a root canal of a tooth. The endodontic file additionally comprises a handle coupled to the conductive shank. The handle is grasped by a thumb and finger of a dentist. The color indicia preferably comprises white, yellow, red, blue and green, with each color representing a different file-length number. In one embodiment of the invention, the non-conductive portion is integral with the conductive shank. In another embodiment of the inventon, the non-conductive portion is selected the group of non-conductive structures consisting of a non-conductive film, a non-conductive sleeve, and combinations thereof.

Embodiments of the present invention also provide an endodontic file assembly comprising a conductive shank having an external surface defining length indicia. A handle is secured to the conductive shank, and an electronic device is electrically coupled to the conductive shank.

Embodiments of the present invention further also provide a method for conducting an endodontic procedure comprising providing an endodontic file assembly having a conductive shank electrically engaged to an electronic device for furnishing current to the conductive shank. A generally non-conductive portion circumscribes the conductive shank. The method also comprises passing the conductive shank including the non-conductive portion into a root canal of a tooth. More particularly, the method additionally comprises passing the conductive shank and the non-conductive portion into a root canal of a tooth until an indicator indicates that the conductive shank has passed beyond the root canal of the tooth. The indicator indicates that the conductive shank has passed beyond the root canal of the tooth by being activated from current passing from a distal end of the conductive shank, through the gums of a patient, and into a ground conductor which is connected to a lip of the patient and to the electronic device.

These provisions together with the various ancillary provisions and features which will become apparent to those skilled in the art as the following description proceeds, are attained by the endodontic methods and endodontic files of the present invention, preferred embodiments thereof being shown with reference to the accompanying drawings, by way of example only, wherein:

### BRIEF DESCRIPTION OF THE DRAWINGS

FIG. 1 is a side view of a prior art file;

FIG. 2 is a schematic diagram of the Apex Locator couple to a prior art file which is slidably seated in a canal of a tooth;

FIG. 3 is a side view of one embodiment of the endodontic file;

FIG. 4 is a side view of another embodiment of the endodontic file;

FIG. 5 is a side view of yet another embodiment of the endodontic file;

FIG. 6 is a further embodiment of the endodontic file illustrating a downwardly tapering file fitted with a handle and having color indicia to indicate file length while disposed in a tooth canal and coupled to an electronic device (e.g., an Apex Locator);

FIG. 7 is also a further embodiment of the endodontic file illustrating a clamp-handle member coupled to the endodontic file; and

FIG. 8 is a file having a suitable handle and length indicia (e.g., 30 mm, 29 mm, 28 mm, etc) longitudinally disposed on the outside thereof.

### DESCRIPTION OF PREFERRED EMBODIMENTS OF THE INVENTION

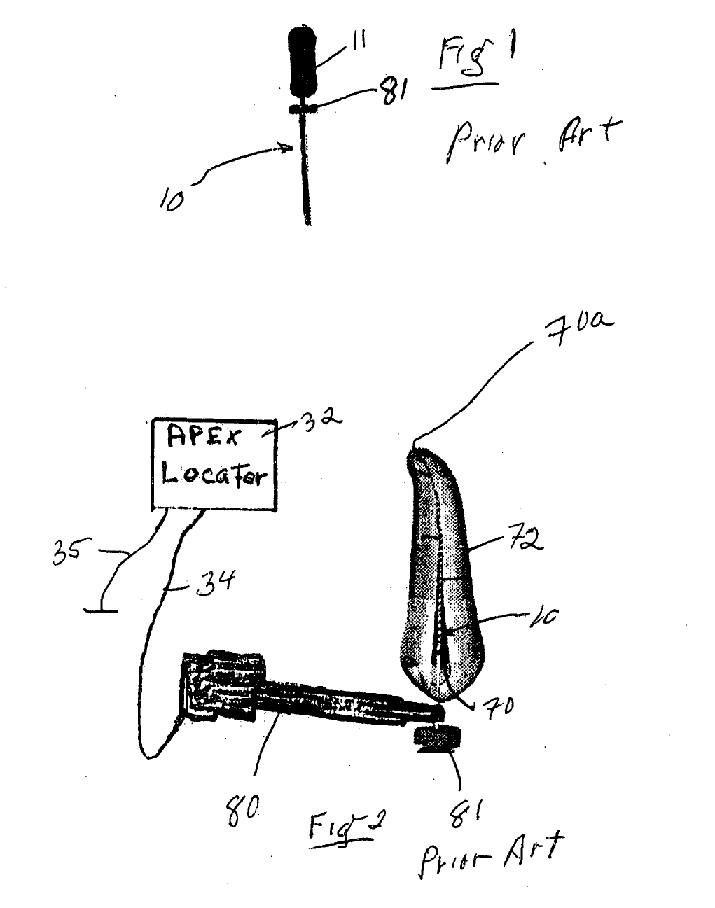

Referring now to FIGS. 1 and 2 of the drawings, and as previously indicated, the electronic device 32 may be part of an Apex Locator assembly. The ground conductor 35 extends from the electronic device 32 to a lip of a patient for grounding purposes. When the file 10 (e.g., prior art file 10 of FIG. 1) leaves the end 70a of the root canal 70 of the tooth 72, the circuit is closed and an indicator (e.g., a light or sound) is activated to inform the dentist that the file 10 has passed beyond end 70a. The circuit is closed by current passing through the gums of a patient, to the ground conductor 35 which is attached to a lip of the patient, and to the electronic device 32. Once the indicator goes off and is activated, a mental clip 80 is detached from prior art file 10 and stopper 81 (see FIG. 2) is pushed down to engage the tooth 72 (i.e., a reference-point). The file 10 is removed from the canal 70 of the tooth 72, and the length of the canal 70 is the length of the file 10 from the stopper 81 to the end of the file 10.

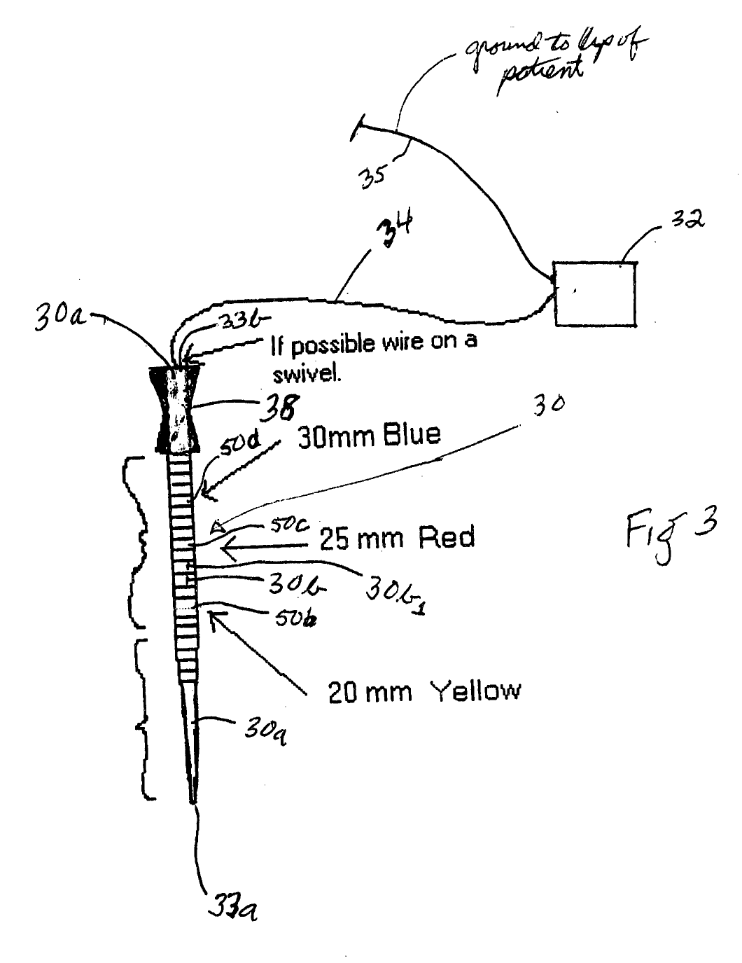

Referring in detail now to FIGS. 3-8 for various preferred embodiments of the invention, there is seen an embodiment of a file, generally illustrated as 30, coupled to the electronic device 32 via conductor 34, to transmit current and receive/emanate signals. The file 30 includes a conductive portion 30a, which may be manufactured of any material or metal that is electrically conductive, and preferably a generally non-conductive portion 30b for cases where a tooth to be treated may have conductive amalgam or a metal crown. If the conductive portion 30a comes in contact with conductive amalgam or a crown, the electronic device 32 could short-out. Preferably conductor 34 is in direct contact with or directly connects to the conductive portion 30a.

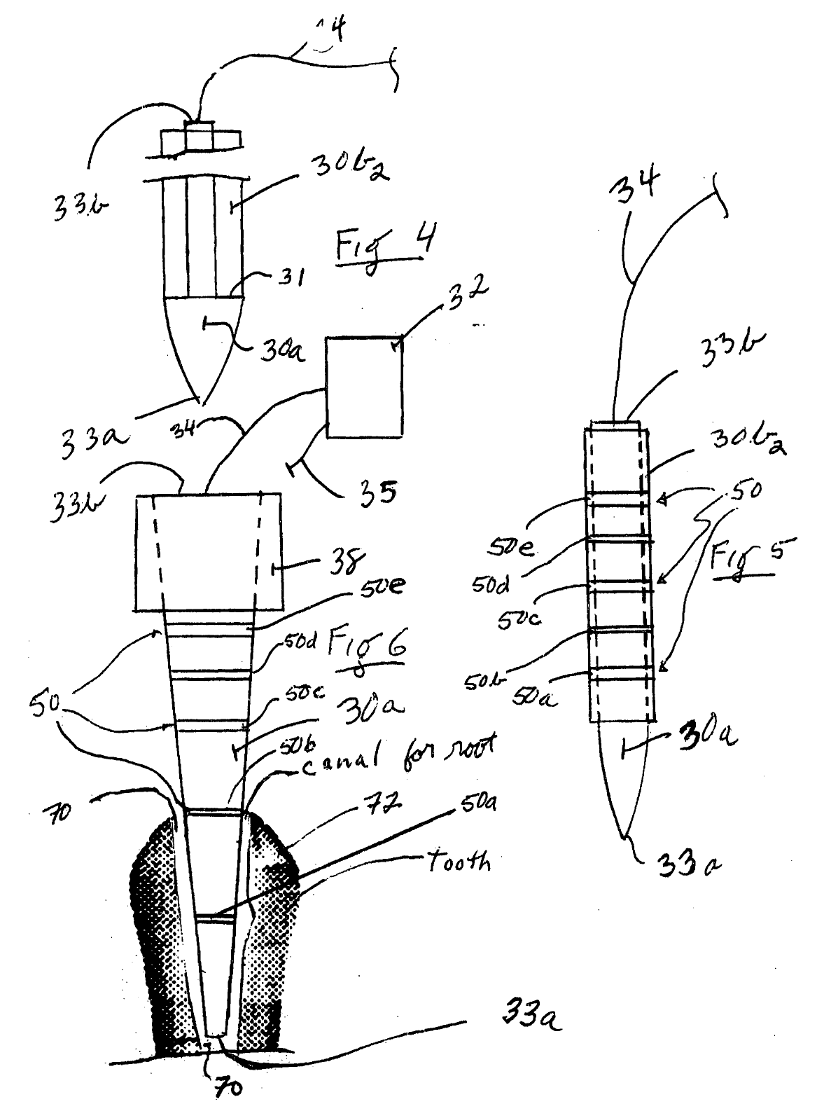

The conductive portion 30a has opposed ends 33a-33b and may taper downwardly from end 33b to end 33a, preferably longitudinally decreasing in size, diameter or thickness (e.g. the largest dimension across a horizontal cross-section). In another embodiment of the invention, conductive portion 30a does not taper longitudinally, but is essentially longitudinally uniform in horizontal cross-section, as best shown in FIGS. 5 and 6.

The file 30 is conveniently fitted with a suitable handle 38 which may be held by a thumb and fingers of a dentist. The conductor 34 may be coupled to the conductive portion 30a of the file by a swivel (not shown), which typically forms part of or seats in the handle 38.

The generally non-conductive portion of 30b is supported by the conductive portion 30a and may possess a number of embodiments. In one preferred embodiment, the non-conductive portion 30b is integral with the conductive portion 30a. In another preferred embodiment, the non-conductive portion 30b is in the form of a coating or film 30b₁, as best shown in FIG. 3 having a thickness of about 0.01 mm. The coating or film 30b₁ may comprise any suitable dielectric or non-conductive material, such as polymeric resin (e.g., a polyimide) an may be disposed on the conductive portion 30a by any suitable manner, such as chemical vapor disposition. In yet another preferred embodiment, the non-conductive portion 30b is in the form of a non-conductive sleeve 30b₂, as best shown in FIGS. 4 and 5. The sleeve 33b₂ is preferably thin, such as ranging from about 0.02 mm to about 0.04 mm in wall thickness. In FIG. 4, non-conductive sleeve 30b₂ is supported by shoulder 31 of conductive portion 30a. In FIG. 5 non-conductive sleeve 30 encircles or surrounds a portion of conductive portion 30a. The non-conductive sleeve 30b₂ may be formed from any suitable dielectric or non-conductive material, such as a suitable non-conductive plastic material, such as by way of example only, polymeric resins (e.g., polyimide, polyethylene, polypropylene, etc.).

In another preferred embodiment of the invention and as previously indicated, because conductive portion 30a may downwardly taper, such as to decrease in size, diameter, or thickness (e.g., the largest dimension across a cross-section) away from end 33b and handle 38, any coating or film 30b₁ and/or sleeve 30b₂ may also downwardly taper and decrease in size, diameter, or thickness correspondingly with the tapering conductive portion 30a. The wall of the sleeve 30b₂ may also decrease in thickness.

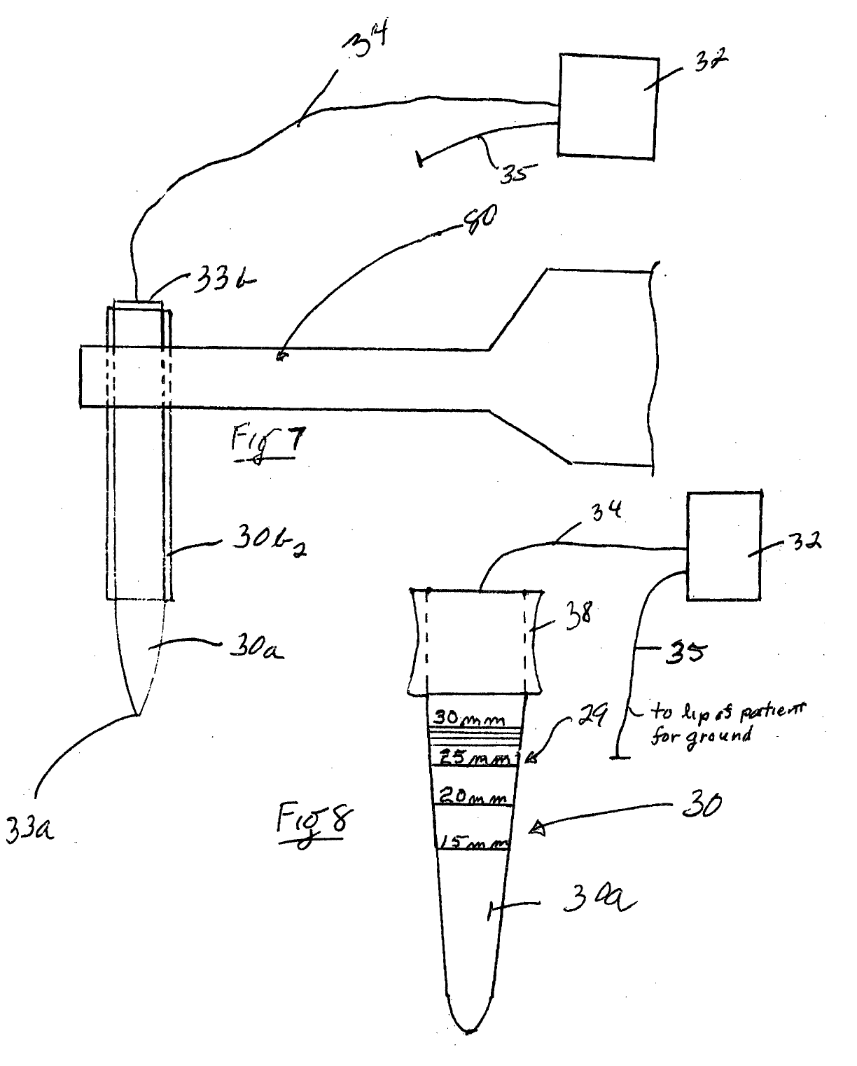

In another embodiment of the invention, color indicia 50 is disposed on the coating or film 30b₁ (see FIG. 3), or on the sleeve 30b₂ (see FIG. 5), or directly on the conductive portion 30a (see FIG. 3) which does not include any coating or film 30b₁ or sleeve 30b₂. In another embodiment of the invention, color indicia 50 functions as an indicator for what portion of the length of the file 30 has passed into a root canal 70 of a tooth 72 (See FIG. 6). Thus, by way of example only, color indicia 50a, 50b, 50c, 50d, and 50e may be white, yellow, red, blue and green, respectively, for representing 15 mm, 20 mm, 25 mm, 30 mm, and 35 mm, respectively. As the file 30 passes into the root canal 70 of a tooth 72 (see FIG. 6), the dentist may readily determine what portion of the length of file 30 from end 33a has passed into the root canal 70. Thus, in FIG. 6, the yellow color indicia 50b indicates that 20 mm of the file 30 (i.e., 20 mm of the conductive portion 30a, or the conductive portion 30a and any dielectric associated therewith) has passed into the root canal 70. Even though the file 30 of the present invention may be fitted with a non-conductive handle 38, it is to be understood that handle 38 may be used in conjunction with clip 80, or may not be replaced by clip 80 (as best shown in FIG. 7) which the dentist may grasp. It is to be also understood that an embodiment of the present invention includes the file 30 without any non-conductive portion 30b, and the conductive portion 30a includes length indicia 29, as opposed to color indicia 50, for indicating length of a root canal 70.

The file 30 of the present invention has wire 34 that carries current from the lower portion of the file 30 to the Apex Locator (or any other electronic devices that may be available and functions similarly). A special feature of the wire 34 is that it comes out from above the handle 38 so that it will not interfere with the length measurement and also makes it easier to advance the file 30 down the root canal 70. This will eliminate the need for the use of the large clip 80 in the mouth. The clip 80 will attach to the one end of the wire 34 (not shown) while the other end of the wire 34 is connected to the Apex Locator. An alternate method is to have a small metal extension (not shown) that protrudes from the back of the handle 38 and then attaches to the clip 80 or another special wire (not shown).

As previously indicated, the file 30 is especially calibrated to lessen the need for a stopper and for removal of the file 30 from a canal to measure the length. The color white is to be placed at 15 mm, yellow is to be placed at 20 mm, red to be placed at 25 mm, blue to be placed at 30 mm, and green to be placed at 35 mm. These colors are traditionally used to correspond to the thickness a file 30 in dentistry. In an embodiment of the present invention, these colors are used to correspond to lengths. The file 30 can then be pushed down the root canal 70 and when the apex is reached, the dentist can read the length without removal of the file 30. Alternatively, a stopper can be used as a marker. When the file 30 is removed, the length is then read from the file 30. Another feature of an embodiment of this invention is that the upper part of the file 30 will be non-conductive. This can be achieved by any suitable type of cover or some type of process that will render the top part of the file 30 non-conductive. This will greatly reduce the problem of shorting out when a metal restoration in a tooth is touched with the file 30.

While the present invention has been described herein with reference to particular embodiments thereof, a latitude of modification, various changes and substitutions are intended in the foregoing disclosure, and it will be appreciated that in some instances some features of the invention will be employed without a corresponding use of other features without departing from the scope and spirit of the invention as set forth. Therefore, many modifications may be made to adapt a particular situation or material to the teachings of the invention and not be limited to the particular embodiment disclosed as the best mode contemplated for carrying out this invention, but that the invention will include all embodiments and equivalents falling within the scope of the appended claims.

1-17. (canceled)

18. An endodontic file comprising a conductive shank having a tip, a tooth-entering lower shank portion terminating in the tip, an upper shank portion bound to the tooth-entering lower shank portion, and color indicia disposed on the tooth-entering lower shank portion of the conductive shank for indicating the length of the tooth-entering lower shank portion which has entered a tooth.

19. The endodontic file of claim 18 wherein said color indicia comprises the color white disposed on the tooth-entering lower shank portion 15 mm from the tip.

20. The endodontic file of claim 18 wherein said color indicia comprises the color yellow disposed on the tooth-entering lower shank portion 20 mm from the tip.

21. The endodontic file of claim 18 wherein said color indicia comprises the color red disposed on the tooth-entering lower shank portion 25 mm from the tip.

22. The endodontic file of claim 18 wherein said color indicia comprises the color blue disposed on the tooth-entering lower shank portion 30 mm from the tip.

23. The endodontic file of claim 18 wherein said color indicia comprises the color green disposed on the tooth-entering lower shank portion 35 mm from the tip.

24. The endodontic file of claim 18 wherein said color indicia comprises the color white disposed on the tooth-entering lower shank portion 15 mm from the tip, the color yellow disposed on the tooth-entering lower shank portion 20 mm from the tip, the color red disposed on the tooth-entering lower shank portion 25 mm from the tip, the color blue disposed on the tooth-entering lower shank portion 30 mm from the tip, and the color green disposed on the tooth-entering lower shank portion 35 mm from the tip.

25. The endodontic file of claim 18 additionally comprising a generally non-conductive portion circumscribing the conductive shank and longitudinally extending along the conductive shank.

26. The endodotic file of claim 18 additionally comprising a generally non-conductive portion circumscribing the tooth-entering lower shank portion of the conductive shank and having said color indicia disposed thereon.

27. The endodontic file of claim 24 additionally comprising a generally non-conductive portion circumscribing the tooth-entering lower shank portion of the conductive shank and having said color indicia disposed thereon.

28. The endodontic file of claim 18 additionally comprising a handle coupled to the upper shank portion for being grasped by a thumb and finger of a person.

29. The endodontic file of claim 18 additionally comprising an electronic device electrically coupled to the conductive shank.

30. The endodontic file of claim 27 wherein said non-conductive portion is selected from the group of no-conductive structure consisting of a non-conductive film a non-conductive sleeve, and combinations thereof.

31. The endodontic file of claim 18 additionally comprising length indicia disposed on said tooth-entering lower shank portion of the conductive shank.

32. The endodontic file of claim 27 additionally comprising length indicia disposed on said non-conductive portion.

33. The endodontic file of claim 19 additionally comprising length indicia disposed contiguously to said color white on said tooth-entering lower shank portion of the conductive shank.

34. The endodontic file of claim 24 additionally comprising length indicia disposed between at least two of said colors of said color indicia.

35. The endodontic file of claim 24 additionally comprising length indicia disposed between said color white and said color yellow.

36. The endodontic file of claim 18 additionally comprising a conductor attaching directly to the conductive shank.

37. The endodontic file of claim 32 additionally comprising a conductor attaching directly to the conductive shank.

38. The endodontic file of claim 18 additionally comprising a first conductor coupled to the conductive shank, an electronic device coupled to the first conductor, and a second conductor coupled to the electronic device and adaptable for connecting to a lip of a person.

39. A method for conducting an endodontic procedure comprising:
providing a conductive shank having a tip, a tooth-entering lower shank portion terminating in the tip, an upper shank portion bound to the tooth-entering lower shank portion, and color indicia disposed on the tooth-entering lower shank portion of the conductive shank and representing the length of the tooth-entering lower shank portion entering a root canal of a tooth;
passing the tooth-entering lower shank portion into a root canal of a tooth; and
viewing the color indicia when in close proximity to the top of the tooth for determining the length of the tooth-entering lower shank portion which has entered into the root canal of the tooth.

40. The method of claim 39 wherein said color indicia comprises the color white disposed on the tooth-entering lower shank portion 15 mm from the tip.

41. The method of claim 39 wherein said color indicia comprises the color yellow disposed on the tooth-entering lower shank portion 20 mm from the tip.

42. The method of claim 39 wherein said color indicia comprises the color red disposed on the tooth-entering lower shank portion 25 mm from the tip.

43. The method of claim 39 wherein said color indicia comprises the color blue disposed on the tooth-entering lower shank portion 30 mm from the tip.

44. The method of claim 39 wherein said color indicia comprises the color green disposed on the tooth-entering lower shank portion 35 mm from the tip.

45. The method of claim 39 wherein said color indicia comprises the color white disposed on the tooth-entering lower shank portion 15 mm from the tip, the color yellow disposed on the tooth-entering lower shank portion 20 mm from the tip, the color red disposed on the tooth-entering lower shank portion 25 mm from the tip, the color blue disposed on the tooth-entering lower shank portion 30 mm from the tip, and the color green disposed on the tooth-entering lower shank portion 35 mm from the tip.

46. The method of claim 39 additionally comprising a generally non-conductive portion circumscribing the conductive shank and longitudinally extending along the conductive shank.

47. The method of claim 39 additionally comprising a generally non-conductive portion circumscribing the tooth-conductive lower shank portion of the conductive shank and having said color indicia disposed thereon.

48. The method of claim 45 additionally comprising a generally non-conductive portion circumscribing the tooth-entering lower shank portion of the conductive shank and having said color indicia disposed thereon.

49. The method of claim 39 wherein said viewing comprises viewing the color white which indicates that 15 mm of the tooth-entering lower shank portion has entered the root canal of the tooth.

50. The method of claim 39 wherein said viewing comprises viewing the color white, and said method additionally comprises subsequently further passing the tooth-entering lower shank portion including the color white into the root canal of the tooth, and viewing the color yellow in close proximity to the top of the tooth.

51. The method of claim 50 wherein said color white indicates that 15 mm of the tooth-entering lower shank portion has entered the root canal of the tooth.

52. The method of claim 50 wherein said color yellow indicates that 20 mm of the tooth-entering lower shank portion has entered the root canal of the tooth.

53. The method of claim 39 wherein said viewing comprises viewing the color white, and said method additionally comprises subsequently further passing the tooth-entering lower shank portion including the color white into the root canal of the tooth, viewing the color yellow, and subsequently further passing the tooth-entering lower shank portion including the color white and the color yellow into the root canal of the tooth, and viewing the color red in close proximity to the top of the tooth.

54. The method of claim 53 wherein said color white indicates that 15 mm of the tooth-entering lower shank portion has entered the root canal of the tooth.

55. The method of claim 53 wherein said color yellow indicates that 20 mm of the tooth-entering lower shank portion has entered the root canal of the tooth.

56. The method of claim 53 wherein said color red indicates that 25 mm of the tooth-entering lower shank portion has entered the root canal of the tooth.

57. The method of claim 39 additionally comprising viewing length indicia disposed on said tooth-entering lower shank portion of the conductive shank.

58. The method of claim 48 additionally comprising viewing length indicia disposed on said non-conductive portion.

59. The method of claim 49 additionally comprising viewing length indicia disposed contiguously to said color white on said tooth-entering lower shank portion of the conductive shank.

60. The method of claim 53 additionally comprising viewing length indicia disposed between at least two of said colors of said color indicia.

61. The method of claim 53 additionally comprising viewing length indicia disposed between said color white and said color yellow.

62. The method of claim 39 wherein said providing additionally comprises a conductor attaching directly to the conductive shank.

63. The method of claim 39 wherein said providing additionally comprises a first conductor coupled to the conductive shank, an electronic device coupled to the first conductor, and a second conductor coupled to the electron device, and said method additionally comprises coupling the second conductor to a lip of a person having the tooth.

64. The method of claim 46 additionally comprising passing the conductive shank and the non-conductive portion into the root canal of the tooth until an indicator indicates that the conductive shank has passed beyond the root canal of the tooth.

65. The method of claim 65 wherein said indicator indicates from being activated by current passing from a distal end of the conductive shank, through the gums of a patient and into a ground conductor which is connected to an electronic device.

66. An endodontic file comprising a conductive shank having a lower shank portion terminating in the tip, an upper shank portion bound to the lower shank portion, color indicia and length indicia contiguously disposed on the lower shank portion of the conductive shank for indicating the length of the lower shank portion which has entered a tooth.

67. The endodontic file of claim 67 wherein said color indicia and length indicia comprise a plurality of colors and length indicators disposed in alternating fashion on said lower shank portion.

68. An endodontic file comprising a conductive shank having a lower shank portion terminating in the tip, an upper shank portion bound to the lower shank portion and having an upper shank side and terminating in a shank conductive end, a non-conductive member surrounding the upper shank side and covering the shank conductive end, and a flexible conductive wire connected directly to the shank conductive end and passing through the non-conductive member at a section of the non-conductive member covering the shank conductive end.
